(19) United States
(12) Patent Application Publication
(10) Pub. No.: US 2005/0250359 A1
(43) Pub. Date: Nov. 10, 2005

(54) Body composition monitor

(76) Inventor: Senri Tanida, Arlington Heights, IL (US)

Correspondence Address: MCDERMOTT WILL & EMERY LLP, 600 13TH STREET, N.W., WASHINGTON, DC, 20005-3096, US

(21) Appl. No.: 11/122,222

(22) Filed: May 5, 2005

(30) Foreign Application Priority Data
Mar. 2, 2005 (JP) 2005-056808
May 6, 2004 (JP) 2004-137363

(51) Int. Cl. H01R 4/66

(52) U.S. Cl. 439/98

(57) ABSTRACT

There is provided a body composition monitor which can retain measurement accuracy by preventing contact between the hands or arms and the sides of a body and allows a subject to grip hand grips in a more relaxed state. The body composition monitor is a body composition monitor comprising impedance measuring means, wherein the impedance measuring means comprises hand grips to contact electrodes for measuring a bioelectrical impedance with the left and right palms, a measurement is made with the hands gripping the hand grips and the arms extended downward along the sides of a body, and the hand grips comprise gripping portions having the electrodes and contact members which contact the body to keep the hands gripping the gripping portions or the arms away from the sides of the body. Thereby, a leakage current associated with formation of a bypass circuit by contact of a hand or arm with the side of a body can be prevented, thereby making a high-accuracy measurement possible. Further, since a subject grips the hand grips with the contact members in contact with the body, the subject can make a stable impedance measurement without tensing muscles to keep a measurement posture.

### BACKGROUND OF THE INVENTION

(i) Field of the Invention

This invention relates to a body composition monitor comprising hand grips for hand electrodes.

(ii) Description of the Related Art

A conventional body composition monitor having hand grips will be described by use of a schematic external view of FIG. 9. The conventional body composition monitor comprises a main unit 1, hand grips 2, chassis 3, and cords 4. The main unit 1 comprises foot electrodes that contact impedance measuring electrodes each comprising a pair of a current applying electrode and a voltage measuring electrode with the bottoms of the left and right feet of a human body, and a body weight measuring section. The hand grips 2 comprise hand electrodes that contact the impedance measuring electrodes with the left and right palms. The chassis 3 connects the hand grips 2 to the main unit 1, comprises a display section and various operation sections which are not shown, and calculates, stores and displays impedances and data about body compositions such as body fat and muscles. The cords 4 electrically connect the hand grips 2 to the chassis 3.

When a subject desires to make a measurement by use of the body composition monitor having the above constitution, the subject stands on the main unit 1 with both hands gripping the hand grips 2 and both arms extended downward along the sides of the body as shown in the figure. In general, when a measurement is made by use of the above hand electrodes to determine, for example, an impedance value between the hands, a current passes through the arms from the current applying electrodes in contact with the palms gripping the hand grips 2 and flows into a body, and the resulting voltage is measured by the voltage measuring electrodes also in contact with the palms. The above body composition monitor calculates data about body compositions such as body fat and muscles in the whole body or specific body parts based on bioelectrical impedances between both hands, between both feet and between a hand and a foot which have been measured by use of the above hand and foot electrodes.

Thus, the body composition monitor having the above constitution has reduced measurement errors caused by a change in bioelectrical impedance associated with movement of body fluid (mainly blood) since a change in posture when a subject stands upright is small, as compared with, for example, an apparatus which causes a subject to grip gripping portion shaving impedance measuring electrodes and extend the arms forward nearly perpendicularly to the body at the time of measurement (refer to Patent Publication 1, for example).

Patent Publication 1

Japanese Patent Laid-Open Publication No. 2001-104272 However, a body composition monitor described in Japanese Patent Laid-Open Publication No. 2001-104272 has a possibility that portions of the hands or arms make contact with the sides of a body in the above measurement posture as shown in the A and B portions circled by dotted lines in the figure. When a measurement is made particularly when water drops exist in portions of the body surface with which the hands or arms make direct contact, e.g., right after bathing or after exercise, at least a portion of currents passing through the arms and flowing into a body from the current applying electrodes contacted with the palms by the hand grips 2 may flow into the body from the sides thereof as if bypass circuits were formed from the above contact portions and influence an impedance measurement as a leakage current on the body surface.

In this case, when arm portions in the vicinity of the armpits which are indicated in the A portions are in contact with the sides of the body, a potential difference is as small as it can be ignored as compared with the normal measurement, while when the hands including the fingers or palms are in contact with the vicinities of the sides of the femoral regions, a potential to be measured may be influenced severely.

Further, as a measurement posture suited to avoid the above influence, a subject need to keep the hands and the arms away from the sides of the body from the shoulder joints with hands gripping the hand grips 2. However, when the subject takes such a measurement posture, a change in bioelectrical impedance caused by a change in muscle cross section associated with tension of muscles may occur, thereby making an impedance measurement unstable.

Therefore, the present invention solves the above problems and provides a body composition monitor comprising hand grips which allow a subject to maintain a stable measurement posture and capable of stable impedance measurement.

### SUMMARY OF THE INVENTION

To solve the above problems, the present invention provides a body composition monitor comprising impedance measuring means, wherein
the impedance measuring means comprises hand grips to contact electrodes for measuring a bioelectrical impedance with the left and right palms,
a measurement is made with the hands gripping the hand grips and the arms extended downward along the sides of a body, and the hand grips comprise gripping portions having the electrodes and contact members which contact the body to keep the hands gripping the gripping portions or the arms away from the sides of the body.

The contact member comprises a contact portion which contacts the side of a body, and fixed portions which are fixed to the gripping portion to keep a distance between the gripping portion and the contact portion.

Further, the contact surface of the contact member which contacts the side of a body has a concave portion formed by a curved surface or flat surfaces in the anteroposterior direction.

Further, the contact member further comprises an angle adjusting portion which adjusts the angle of the contact surface which contacts the side of a body according to the shape of the side of the body.

Further, the contact member further comprises a distance adjusting portion which adjusts a distance between the gripping portion and the contact surface which contacts the side of a body.

In the body composition monitor of the present invention, the hand grips to contact the electrodes for measuring a bioelectrical impedance with the left and right palms comprise the gripping portions having the electrodes and the contact members which contact a body to keep the hands gripping the gripping portions or the arms away from the sides of the body. Thus, a leakage current associated with formation of a bypass circuit by contact of a hand or arm with the side of a body can be prevented, thereby making a high-accuracy measurement possible. Further, since a subject grips the hand grips with the contact members in contact with the body, the subject can make a stable impedance measurement without tensing muscles to keep a measurement posture.

Further, when the contact member comprises a contact portion which contacts the side of a body and fixed portions which are fixed to the gripping portion to keep a distance between the gripping portion and the contact portion, it can be produced with a simple constitution and at low cost.

Further, when the contact surface of the contact member which contacts the side of a body has a concave portion formed by a curved surface or flat surfaces in the anteroposterior direction, the contact member can be attached to the side of a body more closely, so that the position of a hand does not move easily with respect to the side of the body. Thereby, a measurement posture can be further stabilized.

Further, when the contact member further comprises an angle adjusting portion which adjusts the angle of the contact surface which contacts the side of a body according to the shape of the side of the body, a subject can maintain a constant measurement posture regardless of the body shape of the subject and without bending the wrist and/or the elbow in an unnatural manner.

Further, when the contact member further comprises a distance adjusting portion which adjusts a distance between the gripping portion and the contact surface which contacts the side of a body, the contact member can be adapted to various body shapes, and a subject can retain a measurement posture suited to his body shape.

### BRIEF DESCRIPTION OF THE DRAWINGS

FIG. 1 is an example of a schematic external view of a body composition monitor of the present invention at the time of measurement.

FIG. 2 is an enlarged view of a hand grip of Example 1 in the C portion in FIG. 1.

FIG. 3 is a diagram showing the hand grip of FIG. 2 from below.

FIG. 4 is an enlarged view of a hand grip of Example 2 in the C portion in FIG. 1.

FIG. 5 is a diagram showing the hand grip of FIG. 2 from below.

FIG. 6 is a diagram showing a hand grip of Example 3 from below.

FIG. 7 is another embodiment of the hand grip of the body composition monitor of the present invention.

FIG. 8 is still another embodiment of the hand grip of the body composition monitor of the present invention.

FIG. 9 is a schematic external view of a conventional body composition monitor at the time of measurement.

### DETAILED DESCRIPTION OF THE PREFERRED EMBODIMENTS

A body composition monitor of the present invention comprises impedance measuring means, wherein
the impedance measuring means comprises hand grips to contact electrodes for measuring a bioelectrical impedance with the left and right palms,
a measurement is made with the hands gripping the hand grips and the arms extended downward along the sides of a body, and the hand grips comprise gripping portions having the electrodes and contact members which contact the body to keep the hands gripping the gripping portions or the arms away from the sides of the body.

The contact member desirably comprises a contact portion which contacts the side of a body and fixed portions which are fixed to the gripping portion to keep a distance between the gripping portion and the contact portion.

Further, the contact surface of the contact member which contacts the side of a body desirably has a concave portion formed by a curved surface or flat surfaces in the anteroposterior direction.

Further, the contact member desirably further comprises an angle adjusting portion which adjusts the angle of the contact surface which contacts the side of a body according to the shape of the side of the body.

Further, the contact member desirably further comprises a distance adjusting portion which adjusts a distance between the gripping portion and the contact surface which contacts the side of a body.

### EXAMPLE 1

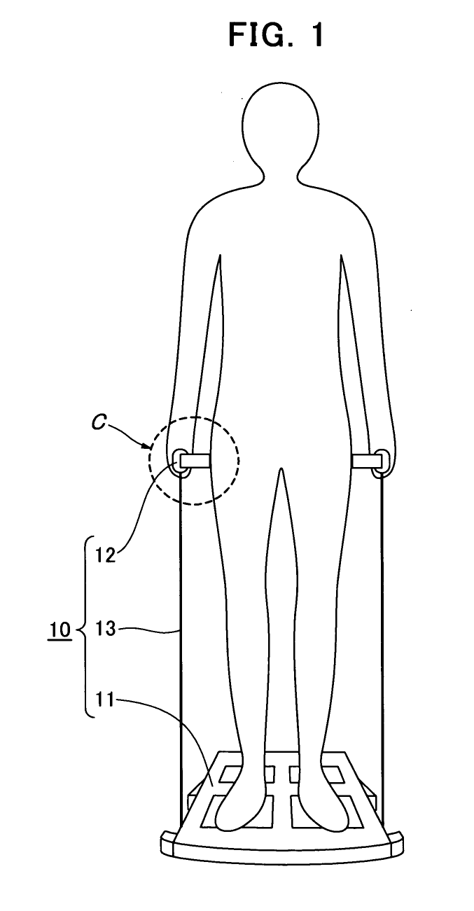

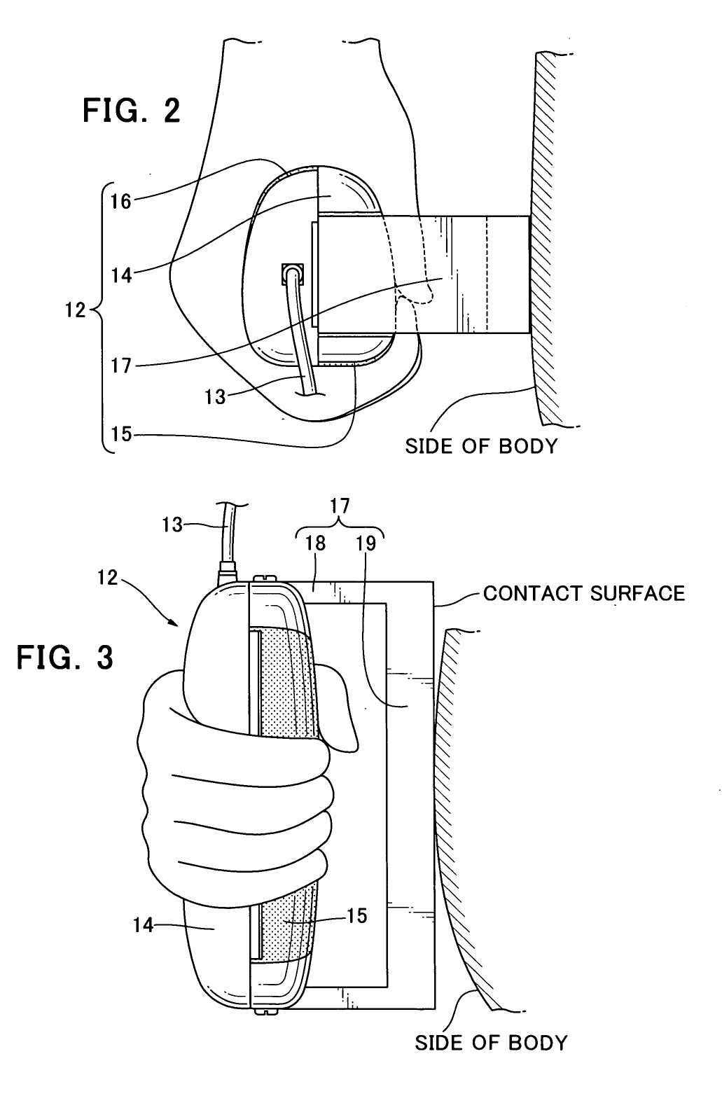

Example 1 of the present invention will be described by use of FIGS. 1 to 3. FIG. 1 is a schematic external view of a body composition monitor having hand grips of the present invention at the time of measurement. FIG. 2 is an enlarged view of the hand grip shown in the C portion in FIG. 1. FIG. 3 is a diagram showing the hand grip of FIG. 2 from below.

A body composition monitor 10 of Example 1 shown in FIG. 1 comprises a main unit 11, two independent hand grips 12 for the left and right hands which are blacked out in FIG. 1, and cords 13 which connect the hand grips 12 to the main unit 11 electrically. The hand grips 12 will be further described later.

The above main unit 11 comprises foot electrodes, an operation section, and a body weight measuring section. The foot electrodes comprise impedance measuring electrodes each of which comprises a pair of a current applying electrode and a voltage measuring electrode, and the impedance measuring electrodes make contact with the bottoms of the left and right feet. The operation section handles turning on/off power, various settings, and inputting physical data. The main unit 11 also incorporates a known impedance measuring and body composition data calculating circuit that calculates, stores and displays impedances and data about body compositions such as fat and muscles.

As shown in FIG. 1, a posture that a subject takes during measurement is similar to that in using the body composition monitor described above in the Description of the Related Art section. That is, to make a measurement, the subject stands upright on the main unit 11 with the hands gripping the hand grips 12 and the arms extended downward along the sides of the body.

Thus, a good measurement posture in which the hands and the arms are kept away from the sides of the body by the hand grips 12 as shown in the C portion in FIG. 1 is attained.

Next, the hand grips 12 will be described in detail by use of FIGS. 2 and 3. However, because the hand grips 12 for the left and right hands have the same configuration, only the hand grip for the right hand shown in the above C portion will be described, and a description of the hand grip for the left hand will be omitted.

FIG. 2 is an enlarged view of the C portion shown in FIG. 1. The hand grip 12 comprises a nearly cylindrical grip body 14 which is a gripping portion to be gripped by the hand. The grip body 14 comprises a current applying electrode 15 that is disposed in an area which makes contact primarily with the finger tips when a subject grips the grip body 14 and a voltage measuring electrode 16 that is disposed in an area which makes contact primarily with the palms. The area in which the voltage measuring electrode 16 is disposed is located nearly opposite to the area in which the current applying electrode 15 is disposed. These electrodes are insulated from each other.

Further, the hand grip 12 comprises a contact member 17 which contacts the side of a body. According to FIG. 3 that shows the hand grip of FIG. 2 from below, the contact member 17 is a member formed in a nearly rectangular shape. Fixed portions 18 which include ends to be screwed to the end faces of the grip body 14 and a contact portion 19 which includes a surface to make contact with the side of a body are integrated to form the contact member 17.

A subject grips the grip bodies 14 of the hand grips 12 and stands upright on the main unit 11 to prepare for a measurement. At that time, the contact member 17 contacts the contact portion 19 with the side of the body and keeps the hand gripping the grip body 14 away from the side of the body by the fixed portions 18. As a result, the whole arms naturally come off the sides of the body, so that the subject does not need to tense his muscles at all to keep the measurement posture. Accordingly, a stable measurement free from the influence of impedance change caused by a change in muscle cross section associated with muscle tension becomes possible.

Descriptions of measurement of impedance and calculations of body composition data will be omitted because they are the same as those performed by a known body composition monitor using eight electrodes.

### EXAMPLE 2

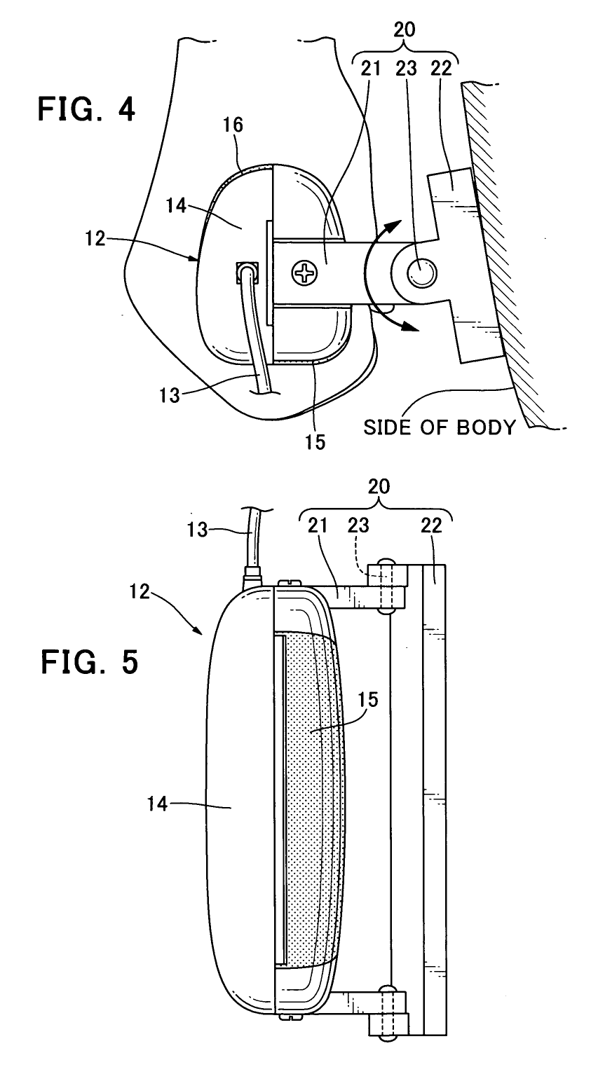

Example 2 of the present invention varies the angle of the contact surface according to concaves and convexes in the vertical direction of the side of a body to keep the grip body 14 gripped and stabilize a measurement posture. The configuration thereof will be described by use of FIGS. 4 and 5. FIG. 4 is an enlarged view of the hand grip in the C portion shown in FIG. 1 modified according to the specification of Example 2. FIG. 5 is a diagram showing the hand grip of FIG. 4 from below.

The configurations and effects of the grip body 14, the current applying electrode 15 and the voltage measuring electrode 16 in FIG. 4 are the same as those of Example 1 shown in FIGS. 2 and 3. Further, the hand grip of Example 2 also comprises an angle adjusting contact member 20. The angle adjusting contact member 20 comprises fixed portions 21 which are screwed to both end faces of the grip body 14 and a contact portion 22 which includes a surface to make contact with the side of a body.

As shown in FIG. 5, the fixed portions 21 and the contact portion 22 are connected to each other by pins 23. The contact portion 22 is connected to the fixed portions 21 rotatably around the pins 23. The contact portion 22 of Example 2 is formed wider in the transverse direction than the contact portion 19 of Example 1.

According to the above configuration of the hand grip, the contact portions 22 can change their angles freely in the vertical direction of the sides of a body when a subject grips the grip bodies 14 and takes a measurement posture in the same manner as in Example 1. Therefore, the subject can keep a natural measurement posture without the need to adjust the contact surfaces to the shapes of the sides of the body by forcibly bending the wrists and/or the elbows, thereby making a stable measurement possible.

### EXAMPLE 3

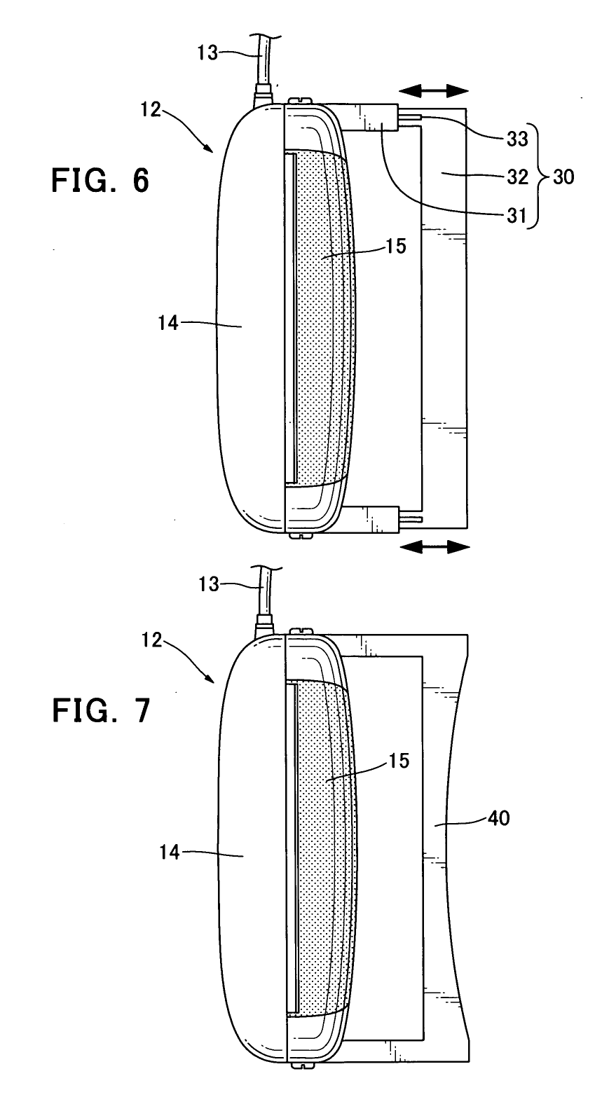

Example 3 of the present invention allows adjustment of the distance between the contact surface and the grip body 14, i.e., the distance between a hand gripping the grip body 14 and the side of a body. The configuration thereof will be described by use of FIG. 6. FIG. 6 is a diagram showing the hand grip in the C portion shown in FIG. 1 modified according to the specification of Example 3 from below.

The configurations and effects of the grip body 14, the current applying electrode 15 and the voltage measuring electrode 16 in FIG. 6 are the same as those of Example 1 shown in FIGS. 2 and 3. Further, the hand grip of Example 3 also comprises a distance adjusting contact member 30. This distance adjusting contact member 30 comprises fixed portions 31 which are screwed to both end faces of the grip body 14 and a contact portion 32 which includes a surface to make contact with the side of a body. The fixed portions 31 and the contact portion 32 are connected to each other by known slide mechanism portions 33 which make it possible to pull the contact portion 32 out of the fixed portions 31 freely and lock the position of the contact portion 32.

According to the above configuration of the hand grip, when a subject grips the grip bodies 14 and takes a measurement posture in the same manner as in Example 1, the contact portion 32 can be slid out of the fixed portions 31 to a position where the hands and the arms do not contact the sides of the body to adjust the distance between the hand and arm and the side of the body. Accordingly, the subject can keep a measurement posture suited to his body shape.

In Examples 1 to 3, the contact surfaces of the contact members 17, 20 and 30 have been illustrated as flat surfaces. However, as shown in FIG. 7 as an example of modification of the contact member 17 of Example 1 shown in FIG. 3, a contact member 40 whose contact surface is curved and concave may be provided. Formation of such a concave increases the contact area between the contact portion and the side of a body and reduces a possibility that the position of the hand moves with respect to the side of the body, so that a stable measurement posture can be taken more easily and a more stable impedance measurement becomes possible. Similarly, a concave formed by flat surfaces may be provided.

Further, although the fixed portions 18, 21 and 31 may be screwed to both end faces of the grip body 14 as described above, they may be integrally formed with the grip body 14. Thereby, they can be produced at low costs.

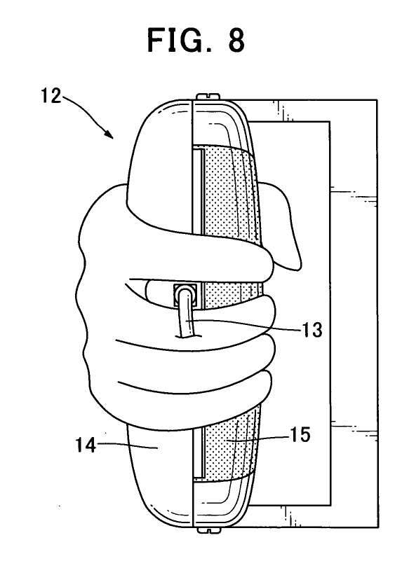

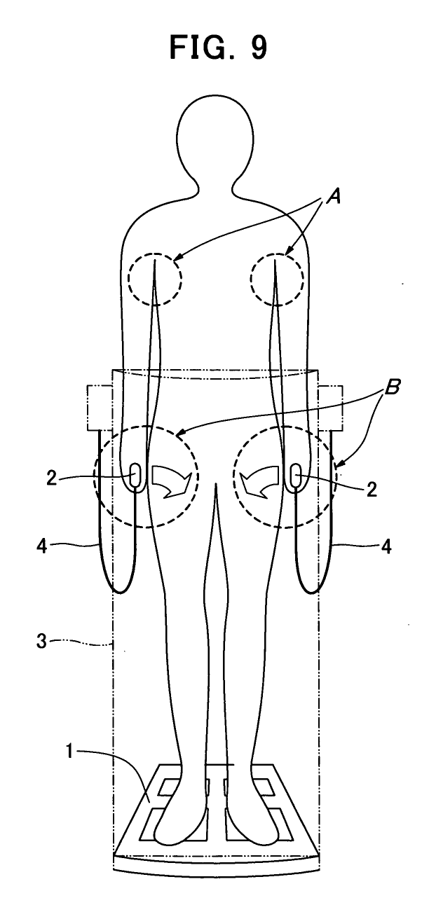

Further, although the cord 13 may be provided to one end face of the grip body 14 as described above, it may be provided at any position which does not adversely affect a measurement posture. For example, the cord 13 can also be provided to a hand grip as shown in FIG. 8 which has the cord 13 provided in the center of the lower portion of the grip body 14 and causes a subject to grip the grip body 14 with the cord 13 sandwiched between the fingers.

Further, although the contact member 17 of Example 1 may be formed in a nearly rectangular shape formed by the fixed portions and the contact portion as described above, space is not necessarily required between the grip body 14 and the contact portion 19, and the contact member 17 may simply be a flat plate having only holes for inserting fingers formed at predetermined positions near the grip 14, for example. With the above alternative configuration of the contact member 17, a subject can always grip the grip body 14 at a nearly constant gripping position, and a stable impedance measurement can be made. Similarly, the fixed portions 21 and 31 of the contact members 20 and 30 described in Examples 2 and 3 may also be constituted as flat plates.

Further, as in Example 2 where the contact condition of the contact surface is stabilized by expanding the contact portion 22 in the transverse direction, the contact portion 19 in Example 1 or the contact portion 32 in Example 3 may also be expanded in the transverse direction to secure the contact area between the contact surface and the side of a body and stabilize the contact condition.

Further, when a hand gripping the hand electrode and an arm are very close to the side of a body in measurement of impedance, particularly impedance between a hand and a foot on the right or left side of the body, by use of a high-frequency current such as 250 kHz or 500 kHz, an electrostatic capacity component is produced between a current path passing through the hand and the arm and a current path passing through the side of the body close to the hand and the arm out of current paths passing between the current applying electrodes contacting the hand and the foot and may influence the measurement of the impedance.

Therefore, the contact member 17, 20 or 30 must keep at least a certain distance which can avoid the above influence in advance between a hand and arm and the side of a body so as to carry out an impedance measurement using a high-frequency current with high accuracy.

1. A body composition monitor comprising impedance measuring means, wherein
the impedance measuring means comprises hand grips to contact electrodes for measuring a bioelectrical impedance with the left and right palms,
a measurement is made with the hands gripping the hand grips and the arms extended downward along the sides of a body, and the hand grips comprise gripping portions having the electrodes and contact members which contact the body to keep the hands gripping the gripping portions or the arms away from the sides of the body.

2. The monitor according to claim 1, wherein the contact member comprises:
a contact portion which contacts the side of a body, and fixed portions which are fixed to the gripping portion to keep a distance between the gripping portion and the contact portion.

3. The monitor according to claim 1 or 2, wherein the contact surface of the contact member which contacts the side of a body has a concave portion formed by a curved surface or flat surfaces in the anteroposterior direction.

4. The monitor according to claim 1 or 2, wherein the contact member further comprises an angle adjusting portion which adjusts the angle of the contact surface which contacts the side of a body according to the shape of the side of the body.

5. The monitor according to claim 1 or 2, wherein the contact member further comprises a distance adjusting portion which adjusts a distance between the gripping portion and the contact surface which contacts the side of a body.
